(19) United States
(12) Patent Application Publication
(10) Pub. No.: US 2025/0308764 A1
(43) Pub. Date: Oct. 2, 2025

(54) COIL COMPONENT

(71) Applicant: TDK Corporation, Tokyo (JP)

(72) Inventors: Kohei Takahashi, Tokyo (JP); Hokuto Eda, Tokyo (JP); Takahiro Nemoto, Tokyo (JP); Hiroki Asafusa, Tokyo (JP); Yuma Usami, Tokyo (JP)

(73) Assignee: TDK Corporation, Tokyo (JP)

(21) Appl. No.: 19/092,006

(22) Filed: Mar. 27, 2025

(30) Foreign Application Priority Data
Mar. 28, 2024 (JP) 2024-054233

(51) Int. Cl. H01F 27/34; H01F 27/28; H01F 27/29; H01F 27/32

(52) U.S. Cl. CPC H01F 27/34; H01F 27/2804; H01F 27/2871; H01F 27/29; H01F 27/323; H01F 2027/2809

(57) ABSTRACT

In the coil component, the first distance on one end surface of the main body portion is longer than the second distance on the other end surface of the main body portion, hence the difference between the coil lengths of the first coil portion and the second coil portion is reduced, so that high coil characteristics are realized.

### CROSS-REFERENCE TO RELATED APPLICATIONS

This application is based upon and claims the benefit of priority from Japanese Patent Application No. 2024-54233, filed on 28 Mar. 2024, the entire content of which is incorporated herein by reference.

### TECHNICAL FIELD

The present disclosure relates to a coil component.

### BACKGROUND

Japanese Patent Laid-Open No. 2017-92444 discloses a coil component in which a double coil is configured by a pair of coil patterns provided on one surface of a substrate and a pair of coil patterns provided on the other surface of the substrate.

The inventors have studied on the coil length of the double coil, and have newly found a technique capable of improving the coil characteristics such as filter characteristics by decreasing the difference of the coil length.

According to various aspects of the present disclosure, a coil component having improved coil characteristics of a double coil is provided.

### SUMMARY

The coil component according to one aspect of the present disclosure includes an element body having a first end surface and a second end surface parallel to each other, an insulating substrate disposed in the element body, extending between the first end surface and the second end surface and orthogonal to the first end surface and the second end surface, a first coil portion including a first planar coil pattern provided on one surface of the insulating substrate, wound around a magnetic core orthogonal to the insulating substrate, and having an inner end and an outer end extending to the first end surface of the element body, a second planar coil pattern provided on the other surface of the insulating substrate, having an inner end overlapping the inner end of the first planar coil pattern when viewed from the thickness direction of the insulating substrate and an outer end extending to the first end surface of the element body, and a first through conductor penetrating the insulating substrate in the thickness direction and connecting the inner end of the first planar coil pattern and the inner end of the second planar coil pattern, a second coil portion having a third planar coil pattern provided on the one surface of the insulating substrate to be wound around in parallel with the first planar coil pattern and having an inner end and an outer end extending to the second end surface of the element body, a fourth planar coil pattern provided on the other surface of the insulating substrate and having an inner end overlapping the inner end of the third planar coil pattern when viewed from the thickness direction of the insulating substrate and an outer end extending to the second end surface of the element body, and a second through conductor penetrating the insulating substrate in the thickness direction and connecting the inner end of the third planar coil pattern and the inner end of the fourth planar coil pattern, and a first external terminal electrode provided on the first end surface of the element body and connected to the outer end of the first planar coil pattern, a second external terminal electrode provided on the first end surface of the element body and connected to the outer end of the second planar coil pattern, a third external terminal electrode provided on the second end surface of the element body and connected to the outer end of the third planar coil pattern, and a fourth external terminal electrode provided on the second end surface of the element body and connected to the outer end of the fourth planar coil pattern, wherein the outer end of the first planar coil pattern exposed on the first end surface and the outer end of the third planar coil pattern exposed on the second end surface are facing in a facing direction of first end surface and the second end surface, the outer end of the second planar coil pattern exposed on the first end surface and the outer end of the fourth planar coil pattern exposed on the second end surface are facing in a facing direction of the first end surface and the second end surface, a first distance on the first end surface is different from a second distance on the second end surface in a direction parallel to the insulating substrate, the first distance is a distance between a connection point of the outer end of the first planar coil pattern and the first external terminal electrode and a connection point of the outer end of the second planar coil pattern and the second external terminal electrode on the first end surface, and the second distance is a distance between a connection point of the outer end of the third planar coil pattern and the third external terminal electrode and a connection point of the outer end of the fourth planar coil pattern and the fourth external terminal electrode on the second end surface.

In the coil component, the first distance on the first end surface and the second distance on the second end surface are different from each other, so that the difference between the coil lengths of the first coil portion and the second coil portion is reduced, and high coil characteristics are realized.

### BRIEF DESCRIPTION OF THE DRAWINGS

FIG. 1 is a schematic perspective view of a coil component according to one embodiment.

FIG. 2 is an exploded view of the coil component shown in FIG. 1.

FIG. 3 is a cross-sectional view taken along line III-III of the coil component shown in FIG. 1.

FIG. 4 is a plane view showing planar coil patterns provided on an upper surface of the substrate.

FIG. 5 is a perspective view showing planar coil patterns provided on a lower surface of the substrate.

FIG. 6A and FIG. 6B show each end surface of the element body shown in FIG. 1.

FIG. 7 is an exploded view of another coil component.

### DETAILED DESCRIPTION

Hereinafter, embodiments of the present disclosure will be described in detail with reference to the accompanying drawings. In the description, the same reference numerals are used for the same elements or elements having the same functions, and redundant description will be omitted.

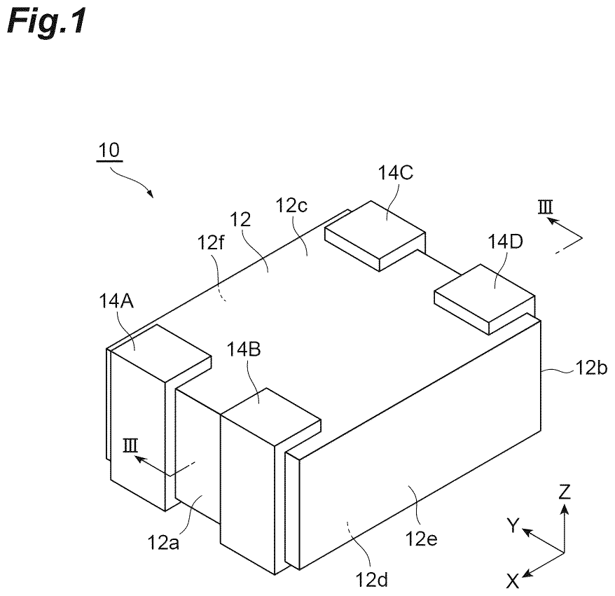

A structure of a coil component 10 according to one embodiment will be described with reference to FIGS. 1 to 3.

The coil component 10 is configured by a main body portion 12 (element body) having a rectangular parallelepiped shape, and two pairs of external terminal electrode 14A, 14B, 14C, and 14D provided on the surface of the main body portion 12. Two pairs of the external terminal electrode 14A, 14B, 14C, and 14D are provided in pairs in end surfaces 12a and 12b parallel to each other of the main body portion 12. The coil component 10 is designed as one example with dimensions of 2.5 mm long side, 2.0 mm short side, 0.8 mm to 1.0 mm height.

In below, for convenience, XYZ coordinates are set as shown in the drawings. That is, the thickness direction of the main body portion 12 is set as Z-direction, the facing direction facing the end surfaces 12a and 12b provided with the external terminal electrode is set as X-direction, and the direction orthogonal to the Z-direction and the X-direction is set as Y-direction. When viewed from the Z-direction, the main body portion 12 exhibits a rectangular shape, and the end surfaces 12a and 12b correspond to a pair of the short sides of the rectangular shape.

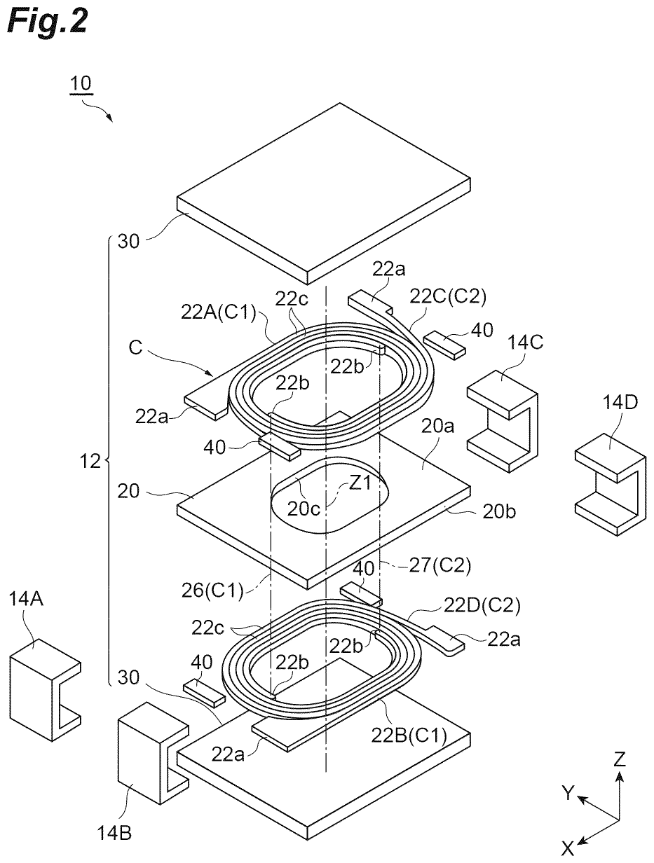

As shown in FIG. 2, the main body portion 12 is configured to include an insulating substrate 20, a coil C disposed in the insulating substrate 20, and a magnetic body 30. The coil C having A magnetic core Z1 orthogonal to the insulating substrate 20 and along the Z-direction.

The insulating substrate 20 is a plate-like member having a rectangular shape provided in the main body portion 12, and is made of a nonmagnetic insulating material. The insulating substrate 20 extends between the end surfaces 12a and 12b, and is designed so as to be orthogonal to the end surfaces 12a and 12b. There exists a through hole 20c having an elliptical shape in the central portion of the insulating substrate 20. A substrate obtained by impregnating a glass cloth with an epoxy-based resin can be used as the insulating substrate 20, which has a thickness of 10 to 60 μm. Other than the epoxy-based resin, a BT resin, a polyimide, an aramid, or the like can be used. Ceramic or glass may be used as the material of the insulating substrate 20. A mass-produced printed substrate material may be used as the material of the insulating substrate 20, or a resin material used for a BT-printed substrate, a FR4 printed substrate, or a FR5 printed substrate may be used.

The coil C comprises a first coil portion C1 and a second coil portion C2 configuring a double coil structure. The first coil portion C1 includes a first planar coil pattern 22A having a planar spiral shape provided on an upper surface 20a (one surface) of the insulating substrate 20, a second planar coil pattern 22B having a planar spiral shape provided on a lower surface 20b (other surface) of the insulating substrate 20, and a first through conductor 26 connecting the first planar coil pattern 22A and the second planar coil pattern 22B. The second coil portion C2 includes a third planar coil pattern 22C having a planar spiral shape provided in the upper surface 20a of the insulating substrate 20, a fourth planar coil pattern 22D having a planar spiral shape provided in the lower surface 20b of the insulating substrate 20, and a second through conductor 27 connecting the third planar coil pattern 22C and the fourth planar coil pattern 22D.

On the upper surface 20a of the insulating substrate 20, the first planar coil pattern 22A of the first coil portion C1 and the third planar coil pattern 22C of the second coil portion C2 are wound around in an adjacent state so as to be parallel. In addition, on the lower surface 20b of the insulating substrate 20, the second planar coil pattern 22B of the first coil portion C1 and the fourth planar coil pattern 22D of the second coil portion C2 are wound around in an adjacent state so as to be parallel.

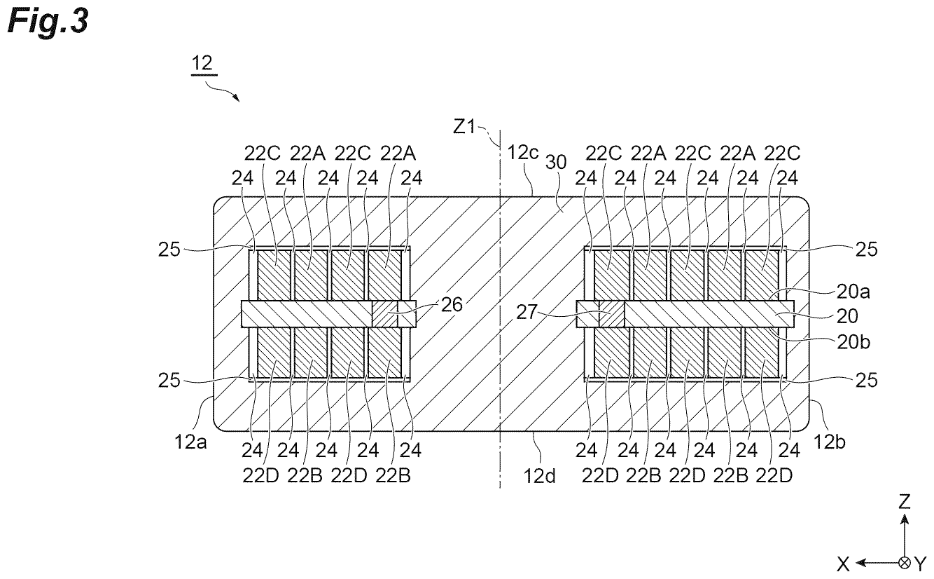

As shown in FIG. 3, each of the planar coil patterns 22A, 22B, 22C, and 22D has a rectangular cross-section and is designed so as to have the same height from the insulating substrate 20. Each of the through conductors 26 and 27 is provided so as to penetrate the insulating substrate 20 in the thickness direction, and has an outer shape of a substantially circular pillar or a substantially prismatic pillar, for example. Each of the through conductors 26 and 27 includes a hole provided in the insulating substrate 20 and a conductive material (for example, metal material such as Cu) may be configured as follows.

Resin walls 24 are provided between the first planar coil pattern 22A and the third planar coil pattern 22C which are wound in parallel on the upper surface 20a of the insulating substrate. The first planar coil pattern 22A and the third planar coil pattern 22C are physically and electrically separated by each resin wall 24. The resin walls 24 are also provided outside the outermost turn and inside the innermost turn of the first planar coil pattern 22A and the third planar coil pattern 22C. In the present embodiment, the resin walls 24 positioned outside the outermost turn and inside the innermost turn are designed to be thicker than the resin wall 24 positioned between the first planar coil pattern 22A and the third planar coil pattern 22C.

Resin walls 24 are also provided between the second planar coil pattern 22B and the fourth planar coil pattern 22D wound in parallel on the lower surface 20b of the insulating substrate 20. The second planar coil pattern 22B and the fourth planar coil pattern 22D are physically and electrically separated by each resin wall 24. The resin walls 24 are also provided outside the outermost turn and inside the innermost turn of the second planar coil pattern 22B and the fourth planar coil pattern 22D. In the present embodiment, the resin walls 24 positioned outside the outermost turn and inside the innermost turn are designed to be thicker than the resin wall 24 positioned between the second planar coil pattern 22B and the fourth planar coil pattern 22D.

The resin wall 24 is configured with an insulating resin material. The resin wall 24 can be provided on the insulating substrate 20 before forming the planar coil patterns 22A, 22B, 22C, and 22D. In this case, the planar coil patterns 22A, 22B, 22C, and 22D are plated and grown in a gap defined by the resin walls 24. That is, the formation region of each of the planar coil patterns 22A, 22B, 22C, and 22D is defined by the resin wall 24 provided on the insulating substrate 20. The resin wall 24 can be provided on the insulating substrate 20 after forming the planar coil patterns 22A, 22B, 22C, and 22D. In this case, the resin walls 24 are provided on the planar coil patterns 22A, 22B, 22C, and 22D by filling, application, or the like.

The height of the resin wall 24 (i.e., the height with reference to the insulating substrate 20) is designed to be higher than the height of each of the planar coil patterns 22A, 22B, 22C, and 22D. As compared with the case in which the height of the resin wall 24 is the same as the height of each of the planar coil patterns 22A, 22B, 22C, and 22D, the creeping distances between the adjacent planar coil patterns 22A, 22B, 22C, and 22D are extended through the resin wall 24. Therefore, a short circuit occurring between adjacent flat coil pattern 22A, 22B, 22C, and 22D is suppressed.

An insulating layer 25 is interposed between the adjacent resin walls 24. The insulating layer 25 is provided over the entire surface of the upper surface of each of the planar coil patterns 22A, 22B, 22C, and 22D. The insulating layer 25 is configured with, for example, epoxy resin or polyimide resin and is formed using a photolithography method.

The magnetic body 30 integrally covers the insulating substrate 20 and the coil C. Specifically, the magnetic body 30 covers the insulating substrate 20 and the coil C from the vertical direction and covers the outer periphery of the insulating substrate 20 and the coil C. The magnetic body 30 also fills the internal of the through hole 20c of the insulating substrate 20 and the inner region of the coil C.

The magnetic body 30 is configured with metal magnetic powder-containing resin. The metal magnetic powder-containing resin is a bound powder in which metal magnetic powder is bound with binder resin. The metal magnetic powder of the metal magnetic powder-containing resin constituting the magnetic body 30 may include magnetic material such as iron-nickel alloy (permalloy), carbonyl iron, amorphous or crystalline FeSiCr alloy, sendust, and the like. In the present embodiment, the content of the metal magnetic powder in the bound powder is 80 to 92 vol. %, and 95 to 99 wt. %. From the viewpoint of the magnetic properties, the content of the metal magnetic powder in the bound powder may be 85 to 92 vol. % and 97 to 99 wt. %. The magnetic powder of the metal magnetic powder-containing resin constituting the magnetic body 30 may be powder having one kind of average particle diameter or mixed powder having a plurality of kinds of average particle diameters. In the present embodiment, the magnetic powder of the metal magnetic powder-containing resin constituting the magnetic body 30 is mixed powder having three kinds of average particle diameters. When the magnetic powder of the metal magnetic powder-containing resin constituting the magnetic body 30 is mixed powder, the types of materials of the magnetic powders having different average particle diameters may be the same or different.

Two pairs of the external terminal electrodes 14A, 14B, 14C, and 14D provided on the end surfaces 12a and 12b of the main body portion 12 are connected to corresponding outer ends 22a of the planar coil patterns 22A, 22B, 22C, and 22D, respectively. That is, a first external terminal electrode 14A and a second external terminal electrode 14B provided on the end surface 12a are connected to the outer ends 22a of the first planar coil pattern 22A and the second planar coil pattern 22B, respectively. A third external terminal electrode 14C and a fourth external terminal electrode 14D provided on the end surface 12b are connected to the outer ends 22a of the second planar coil pattern 22B and the fourth planar coil pattern 22D, respectively.

The first external terminal electrode 14A and the third external terminal electrode 14C face each other along the X-direction, and the second external terminal electrode 14B and the fourth external terminal electrode 14D face each other along the X-direction.

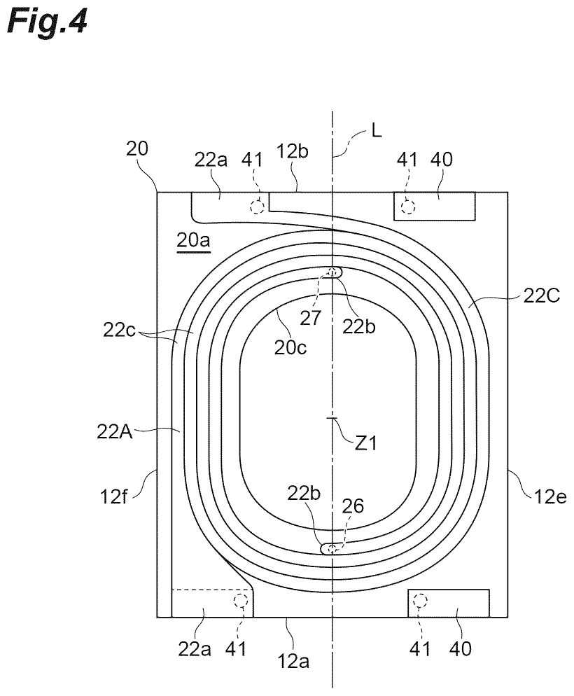

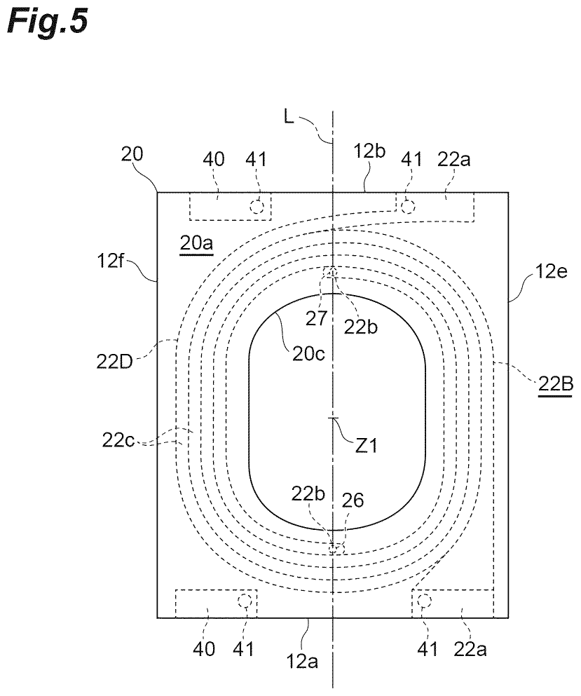

Next, the pattern shapes of each of the planar coil patterns 22A, 22B, 22C, and 22D will be described in detail with reference to FIGS. 4 and 5. One dot chain lines in FIGS. 4 and 5 indicate equidistant lines L in which the distance to the side surface 12e and the distance to the side surface 12f are equal when viewed from the Z-direction.

Each of the planar coil patterns 22A, 22B, 22C, and 22D is wound around the through hole 20c at the central portion of the insulating substrate 20. The magnetic core Z1 of the coil C penetrates the magnetic body 30 that fills the internal of the through hole 20c of the insulating substrate 20 and the inner region of the coil C.

Each of the planar coil patterns 22A, 22B, 22C, and 22D has the outer end 22a reaching and exposed on the end surface 12a or 12b of the main body portion 12, an inner end 22b provided at the peripheral edge of the through hole 20c, and a winding portion 22c connecting the outer end 22a and the inner end 22b.

The inner end 22b of the first planar coil pattern 22A is located on the equidistant line L at the peripheral edge of the through hole 20c, and is located on the end face 12a side with respect to the through hole 20c when viewed from the Z-direction. The first through conductor 26 extending in the Z-direction is provided at a position overlapping the inner end 22b of the first planar coil pattern 22A. That is, the first through conductor 26 is located on the equidistant line L. The first through conductor 26 is in contact with the first planar coil pattern 22A at the upper end surface thereof and with the second planar coil pattern 22B at the lower end surface thereof.

The outer end 22a of the first planar coil pattern 22A extends to the end surface 12a and is connected with the first external terminal electrode 14A on the end surface 12a. The outer end 22a of the first planar coil pattern 22A exhibits a rectangular shape extending along the end surface 12a when viewed from the Z-direction. The outer end 22a of the first planar coil pattern 22A is located on the side surface 12f side with respect to the equidistant line L.

The winding portion 22c of the first planar coil pattern 22A configures a part of the innermost turn and a part of the outermost turn of the planar coil patterns 22A and 22C located on the upper surface 20a of the insulating substrate 20. The winding number of the winding portion 22c of the first planar coil pattern 22A is approximately two winding (two turns).

The inner end 22b of the third planar coil pattern 22C is located on the equidistant line L at the peripheral edge of the through hole 20c, and is located on the end face 12b side with respect to the through hole 20c when viewed from the Z-direction. In the present embodiment, the inner end 22b of the first planar coil pattern 22A and the inner end 22b of the third planar coil pattern 22C are designed to sandwich the magnetic core Z1 on the equidistant line L.

The second through conductor 27 extending in the Z-direction is provided at a position overlapping the inner end 22b of the third planar coil pattern 22C. That is, the first through conductor 26 and the second through conductor 27 are arranged to sandwich the magnetic core Z1 on the equidistant line L The second through conductor 27 is in contact with the third planar coil pattern 22C at the upper end surface thereof and with the fourth planar coil pattern 22D at the lower end surface thereof.

The outer end 22a of the third planar coil pattern 22C extends to the end surface 12b and is connected with the third external terminal electrode 14C on the end surface 12b. The outer end 22a of the third planar coil pattern 22C exhibits a rectangular shape extending along the end surface 12b when viewed from the Z-direction. The outer end 22a of the third planar coil pattern 22C is located on the side surface 12f side with respect to the equidistant line L. The outer end 22a of the third planar coil pattern 22C faces the outer end 22a of the first planar coil pattern 22A along the X-direction.

The winding portion 22c of the third planar coil pattern 22C is wound in a state adjacent to the winding portion 22c of the first planar coil pattern 22A. The winding number of the winding portion 22c of the third planar coil pattern 22C is almost the same as the winding number of the winding portion 22c of the first planar coil pattern 22A, which is approximately two winding (two turns). The winding portion 22c of the third planar coil pattern 22C is wound to be sandwiched in the winding portion 22c of the first planar coil pattern 22A.

The inner end 22b of the second planar coil pattern 22B is located on the equidistant line L at the peripheral edge of the through hole 20c, and is located on the end surface 12a side with respect to the through hole 20c when viewed from the Z-direction.

The outer end 22a of the second planar coil pattern 22B extends to the end surface 12a and is connected with the second external terminal electrode 14B on the end surface 12a. The outer end 22a of the second planar coil pattern 22B exhibits a rectangular shape extending along the end surface 12a when viewed from the Z-direction. The outer end 22a of the second planar coil pattern 22B is located on the side surface 12e side with respect to the equidistant line L.

The winding portion 22c of the second planar coil pattern 22B configures a part of the innermost turn and a part of the outermost turn of the planar coil patterns 22B and 22D located in the lower surface 20b of the insulating substrate 20. The winding number of the winding portion 22c of the second planar coil pattern 22B is approximately two winding as same as the winding number of the winding portion 22c of the first planar coil pattern 22A. y2 winding.

The inner end 22b of the fourth planar coil pattern 22D is located on the equidistant line L at the peripheral edge of the through hole 20c, and is located on the end surface 12b side with respect to the through hole 20c when viewed from the Z-direction. In the present embodiment, the inner end 22b of the second planar coil pattern 22B and the inner end 22b of the fourth planar coil pattern 22D are arranged to sandwich the magnetic core Z1 on the equidistant line L.

The outer end 22a of the fourth planar coil pattern 22D extends to the end surface 12b and is connected with the fourth external terminal electrode 14D on the end surface 12b. The outer end 22a of the fourth planar coil pattern 22D exhibits a rectangular shape extending along the end surface 12b when viewed from the Z-direction. The outer end 22a of the third planar coil pattern 22C is located on the side surface 12e side with respect to the equidistant line L. The outer end 22a of the fourth planar coil pattern 22D faces the outer end 22a of the second planar coil pattern 22B along the X-direction.

The winding portion 22c of the fourth planar coil pattern 22D is wound to be sandwiched with the winding portion 22c of the second planar coil pattern 22B. The winding number of the winding portion 22c of the fourth planar coil pattern 22D is almost the same as the winding number of the winding portion 22c of the second planar coil pattern 22B, which is approximately two winding (two turns). The winding portion 22c of the fourth planar coil pattern 22D is wound to be sandwiched in the winding portion 22c of the second planar coil pattern 22B.

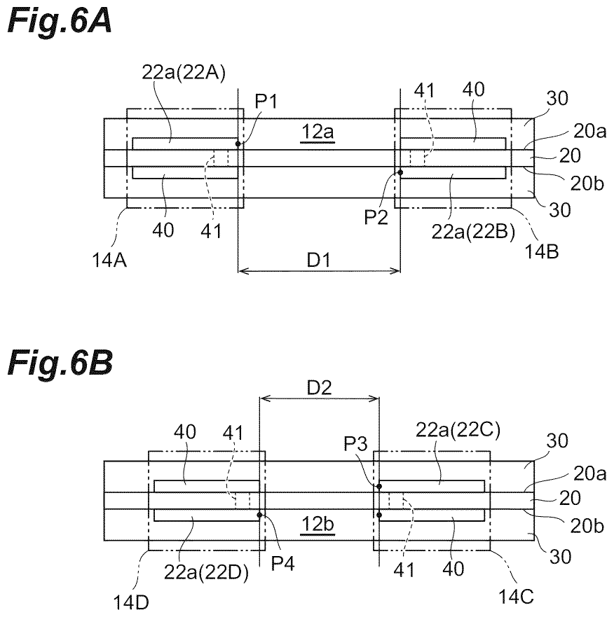

In the present embodiment, four pair electrodes 40 are provided on the insulating substrate 20. Each of the pair electrodes 40 overlaps with the outer end 22a of each of the planar coil patterns 22A, 22B, 22C, and 22D through the insulating substrate 20. The pair electrode 40 and the outer end 22a are connected to each other by through conductors 41 provided in the insulating substrate 20. Each of the pair electrodes 40 has the same shape (rectangular shape) as each of the outer ends 22a when viewed from the Z-direction. The outer end 22a of each of the planar coil patterns 22A, 22B, 22C, and 22D is duplexed by each of the pair electrodes 40, and electrical connectivity with the external terminal electrodes 14A, 14B, 14C, and 14D is enhanced. It is not necessary to duplex the outer ends 22a of all of the planar coil pattern 22A, 22B, 22C, and 22D, and only a part of the outer ends 22a of the planar coil patterns 22A, 22B, 22C, and 22D may be duplexed. The shape of each of the pair electrodes 40 may be a shape that is wholly superposed with the outer end 22a or may be a shape that is partially superposed when viewed from the Z-direction. The position of each of the pair electrodes 40 with respect to the direction parallel to the insulating substrate 20 (i.e., lateral direction in FIGS. 6A and 6B) may be the same position as the outer end 22a or the shifted position from the outer end 22a.

As shown in FIGS. 6A and 6B, a distance D1 is different from a distance D2. The distance D1 is a distance, with respect to the direction parallel to the insulating substrate 20 (i.e., lateral direction in FIG. 6A), between a connection point P1 in which the outer end 22a of the first planar coil pattern 22A and the first external terminal electrode 14A on the end surface 12a are connected and a connection point P2 in which the outer end 22a of the second planar coil pattern 22B and the second external terminal electrode 14B are connected. The distance D2 is a distance, with respect to the direction parallel to the insulating substrate 20 (i.e., lateral direction in FIG. 6B), between a connection point P3 in which the outer end 22a of the third planar coil pattern 22C and the third external terminal electrode 14C on the end surface 12b are connected and a connection point P4 in which the outer end 22a of the fourth planar coil pattern 22D and the fourth external terminal electrode 14D are connected. In particular, the distance D2 is designed to be shorter than the distance D1 (D1>D2). In this case, in the vicinity of the end face 12b of the main body portion 12, the coil lengths of the third planar coil pattern 22C and the fourth planar coil pattern 22D extracting to the end face 12b become short. The connection point P3 of the outer end 22a of the third planar coil pattern 22C and the third external terminal electrode 14C becomes closer to the equidistant line L, the shorter the coil length of the third planar coil pattern 22C. Similarly, the connection point P4 of the outer end 22a of the fourth planar coil pattern 22D and the fourth external terminal electrode 14D becomes closer to the equidistant line L, the shorter the coil length of the fourth planar coil pattern 22D.

As in the above coil component 10, in a case where the coil C is a double coil configured by the first coil portion C1 and the second coil portion C2, the outer end 22a of the first planar coil pattern 22A and the outer end 22a of the third planar coil pattern 22C face each other along the X-direction, and the outer end 22a of the second planar coil pattern 22B and the outer end 22a of the fourth planar coil pattern 22D face each other along the X-direction, the coil length of the first coil portion C1 may be longer than the coil length of the second coil portion C2. For example, a case using the coil component 10 as a common mode filter, the first external terminal electrode 14A connected to the first coil portion C1 and the third external terminal electrode 14C connected to the second coil portion C2 are used as input terminals, and the second external terminal electrode 14B connected to the first coil portion C1 and the fourth external terminal electrode 14D connected to the second coil portion C2 are used as output terminals. In this case, the difference between the coil lengths of the first coil portion C1 and the second coil portion C2 influence the coil characteristics such as filter characteristics.

In a case that the first external terminal electrode 14A and the second external terminal electrode 14B connected to the first coil portion C1 are provided on the same element body surface (that is, the end surface 12a) and a case that the third external terminal electrode 14C and the fourth external terminal electrode 14D connected to the second coil portion C2 are provided on the same element body surface (that is, the end surface 12b), a short circuit on the end surfaces 12a and 12b may be suppressed. In particular, in a case that a difference between voltages respectively applied to the first coil portion C1 and the second coil portion C2 is relatively large, when an external terminal electrode connected to the first coil portion C1 and an external terminal electrode connected to the second coil portion C2 are provided on the same surface, a short circuit of the external terminal electrodes may occur, but when the external terminal electrodes 14A and 14B connected to the first coil portion C1 are provided on the same surface, a short circuit of the external terminal electrodes 14A and 14B is less likely to occur. Similarly, when the external terminal electrode 14C and 14D connected to the second coil portion C2 are provided on the same surface, a short circuit of the external terminal electrodes 14C and 14D is less likely to occur.

In the above the coil component 10, the first distance D1 on the end surface 12a of the main body portion 12 is longer than the second distance D2 on the end surface 12b, and thus the difference between the coil lengths of the first coil portion C1 and the second coil portion C2 is reduced (or the coil lengths are the same), so that high coil characteristics are realized.

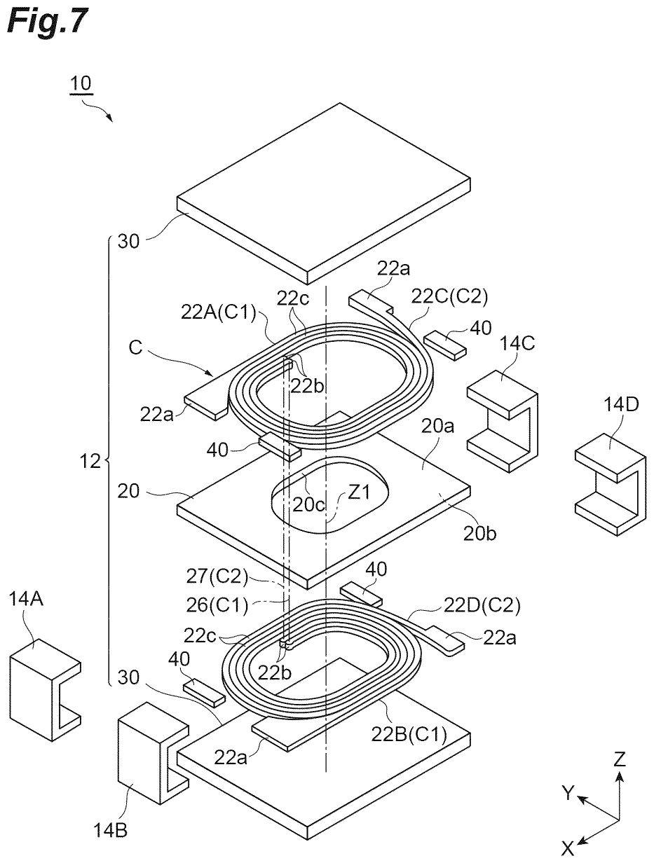

The difference between the coil lengths of the first coil portion C1 and the second coil portion C2 can be adjusted not only when the first distance D1 on the end surface 12a of the main body portion 12 is longer than the second distance D2 on the end surface 12b but when the first distance D1 on the end surface 12a of the main body portion 12 is shorter than the second distance D2 on the end surface 12b. For example, as shown in FIG. 7, when viewed from the Z-direction, in the case that the first coil portion C1 and the second coil portion C2 are wound so that the through conductors 26 and 27 are adjacent to each other, the difference between the coil lengths of the first coil portion C1 and the second coil portion C2 may occur other than at the vicinity of the end surfaces 12a and 12b. In such a case, the difference between the coil lengths of the first coil portion C1 and the second coil portion C2 can be reduced (or the coil lengths can be made the same) by making the first distance D1 on the end surface 12a of the main body portion 12 and the second distance D2 on the end surface 12b different.

What is claimed is:

1. A coil component comprising:
an element body having a first end surface and a second end surface parallel to each other;
an insulating substrate disposed in the element body, extending between the first end surface and the second end surface and orthogonal to the first end surface and the second end surface;
a first coil portion including a first planar coil pattern provided on one surface of the insulating substrate, wound around a magnetic core orthogonal to the insulating substrate, and having an inner end and an outer end extending to the first end surface of the element body, a second planar coil pattern provided on the other surface of the insulating substrate, having an inner end overlapping the inner end of the first planar coil pattern when viewed from the thickness direction of the insulating substrate and an outer end extending to the first end surface of the element body, and a first through conductor penetrating the insulating substrate in the thickness direction and connecting the inner end of the first planar coil pattern and the inner end of the second planar coil pattern;
a second coil portion having a third planar coil pattern provided on the one surface of the insulating substrate to be wound around in parallel with the first planar coil pattern and having an inner end and an outer end extending to the second end surface of the element body, a fourth planar coil pattern provided on the other surface of the insulating substrate and having an inner end overlapping the inner end of the third planar coil pattern when viewed from the thickness direction of the insulating substrate and an outer end extending to the second end surface of the element body, and a second through conductor penetrating the insulating substrate in the thickness direction and connecting the inner end of the third planar coil pattern and the inner end of the fourth planar coil pattern; and
a first external terminal electrode provided on the first end surface of the element body and connected to the outer end of the first planar coil pattern, a second external terminal electrode provided on the first end surface of the element body and connected to the outer end of the second planar coil pattern, a third external terminal electrode provided on the second end surface of the element body and connected to the outer end of the third planar coil pattern, and a fourth external terminal electrode provided on the second end surface of the element body and connected to the outer end of the fourth planar coil pattern,
wherein the outer end of the first planar coil pattern exposed on the first end surface and the outer end of the third planar coil pattern exposed on the second end surface are facing in a facing direction of first end surface and the second end surface, the outer end of the second planar coil pattern exposed on the first end surface and the outer end of the fourth planar coil pattern exposed on the second end surface are facing in a facing direction of the first end surface and the second end surface,
a first distance on the first end surface is different from a second distance on the second end surface in a direction parallel to the insulating substrate, the first distance is a distance between a connection point of the outer end of the first planar coil pattern and the first external terminal electrode and a connection point of the outer end of the second planar coil pattern and the second external terminal electrode on the first end surface, and the second distance is a distance between a connection point of the outer end of the third planar coil pattern and the third external terminal electrode and a connection point of the outer end of the fourth planar coil pattern and the fourth external terminal electrode on the second end surface.

2. The coil component according to claim 1, wherein the second distance on the second end surface is less than the first distance on the first end surface.

3. The coil component according to claim 1, wherein the second distance on the second end surface is greater than the first distance on the first end surface.

4. The coil component according to claim 1, wherein the first through conductor of the first coil portion and the second through conductor of the second coil portion are arranged with the magnetic core interposed therebetween when viewed from a thickness direction of the insulating substrate.

5. The coil component according to claim 1, wherein the first through conductor of the first coil portion and the second through conductor of the second coil portion are adjacent to each other when viewed from a thickness direction of the insulating substrate.

6. The coil component according to claim 1, wherein at least one of the outer ends of the first planar coil pattern, the second planar coil pattern, the third planar coil pattern, and the fourth planar coil pattern is duplexed by a pair electrode overlapping via the insulating substrate and connected by a through conductor provided in the insulating substrate.

7. The coil component according to claim 6, wherein the pair electrode is away from the outer end in a direction parallel to the insulating substrate.

8. The coil component according to claim 1, wherein the element body is a rectangular shape when viewed from the thickness direction of the insulating substrate, and the first end surface and the second end surface respectively correspond to a pair of short sides of the rectangular.
